(19) United States
(12) Patent Application Publication
(10) Pub. No.: US 2017/0152788 A1
(43) Pub. Date: Jun. 1, 2017

(54) Internal Combustion Engine Coolant Apparatus

(71) Applicant: Concentric Birmingham Limited, Birmingham (GB)

(72) Inventors: Paul Shepherd, Birmingham (GB); Gavin Newman, Birmingham (GB)

(21) Appl. No.: 15/355,980

(22) Filed: Nov. 18, 2016

(30) Foreign Application Priority Data
Nov. 27, 2015 (GB) 1521010.7
Aug. 16, 2016 (GB) 1614028.7

(51) Int. Cl. F01P 5/12; F01P 7/14; F16H 3/66; F04D 29/18; F16H 3/54; F01P 3/20; F04D 13/02

(52) U.S. Cl. CPC F01P 5/12; F01P 3/20; F01P 7/14; F04D 13/028; F04D 29/18; F16H 3/54; F16H 3/66; F16H 2200/0034; F16H 2200/2005; F16H 2200/2033; F16H 2200/2007

(57) ABSTRACT

A vehicle coolant pump has an impeller and pump gearbox having one or two planetary gear sets each having a selectable gear ratio. The gear sets may be connected in series to provide a compact gearbox which can operate at a number of different selectable gear ratios.

### FIELD OF THE INVENTION

The present invention is concerned with an internal combustion (IC) engine coolant apparatus. More specifically, the present invention is concerned with an internal combustion engine coolant pump comprising at least one planetary gearbox with at least two gear ratios being selectable based on an external signal or control.

### BACKGROUND OF THE INVENTION

Internal combustion engines have many uses—for example they may be used to power on- and off-highway vehicles, or for power generation. Many internal combustion (IC) engines have a fluid-based cooling system in order to keep the engine at the optimum temperature. Such cooling systems typically employ a liquid medium to transfer heat energy from parts of the engine that are prone to overheating to other parts of the engine or vehicle (e.g. a radiator for heat dissipation). This is particular important for heavy commercial vehicles such as goods vehicles, and heavy goods vehicles (HGVs) in particular.

IC engines are provided with a cooling circuit containing the coolant. The circuit extends from a heat source (such as the engine block) to an appropriate heat sink (such as the vehicle radiator). Pumping fluid around the circuit ensures transmission and dissipation of heat energy. A coolant pump is provided, the pump comprising an impeller driven by a shaft. A pump pulley is mounted to the shaft. The engine crankshaft also has a pulley mounted thereto, and a belt drive drivingly engages the crankshaft and pump pulleys such that the impeller is driven by the crankshaft.

Although a gear ratio may be provided by appropriately sizing the pulleys, in such systems the speed of the input shaft (and hence the impeller) is proportional to the speed of the engine. As such the size of the pulleys must be selected to provide sufficient cooling for the most demanding situation.

In certain circumstances it is desirable to reduce the effect of the cooling circuit. For example, upon startup it is desirable for the IC engine to heat up to its optimum operating temperature quickly. Therefore, conduction and convection of thermal energy away from the engine block is not desirable. Once the engine is up to temperature, and perhaps undergoing a heavy duty cycle, it is important that the coolant system can work at maximum effectiveness to avoid overheating. It is always desirable to reduce unnecessary coolant flow because this creates a parasitic power loss. Reduction in unnecessary flow of coolant can therefore provide a fuel saving.

In order to address this need, some prior art systems have been provided to either alter the ratio between the crankshaft and the impeller or to make the impeller speed completely independent of the crankshaft speed. Some systems use viscous or magnetic couplings to vary the ratio between crankshaft and impeller. Variable speed electric motors have also been proposed to directly drive the impeller independent of crankshaft speed. All of these types of drivetrain are complex, expensive, and susceptible to losses, receding the efficiency of the engine.

What is required is a robust, mechanical solution that offers a wide range of gear ratios, but with few losses. It is also important that the solution is compact to fit into the typically crowded environments in which IC engines are found.

What is also required is a system which allows for a failsafe condition which will provide the maximum pumping condition so as to prevent the engine from becoming too hot.

### SUMMARY OF THE INVENTION

According to a first aspect of the present invention, there is provided an internal combustion engine coolant apparatus comprising:

an input shaft;

an output shaft configured to drive an impeller; and,

a gearbox between the input shaft and the output shaft, the gearbox comprising:

a planetary gear set configured to be driven by the input shaft, the gearbox being switchable between:

a first condition in which the planetary gear set has a first gear ratio; and,

a second condition in which the planetary gear set has a second ratio lower than the first; and,

an electrically powered actuator configured to switch between the first and second conditions;

in which the gearbox has a failsafe condition in which the first condition is entered upon interruption of power to the electrically powered actuator.

Advantageously, the provision of a failsafe condition at a higher gear ratio means that upon interruption of the power supply to the actuator, the pump effect defaults to a maximum. This is beneficial as it avoids engine overheating if the engine is then worked hard.

Preferably the actuator is configured to drive a displaceable drive member in the form of an annular drive plate between the first and second conditions, in which the drive plate is resiliently biased to the first condition. The drive plate may be biased by a spring. This provides the failsafe functionality.

Preferably the actuator comprises an electromagnet configured to urge the drive plate into the second condition. The electromagnet may be a solenoid configured to attract the drive plate at least partially constructed from a material responsive to a magnetic field. Direct actuation of the drive plate allows for a light and compact arrangement.

Preferably the electromagnet is annular in shape, centred on a main axis of the gear set. This provides an even force ensuring that linear motion results. Preferably the drive plate is non-rotatably but linearly moveably mounted relative to the input shaft, for example via a spline.

Preferably the output shaft is driven by a planet carrier of the planetary gear set.

Preferably there is provided a clutch between the drive plate and the planet carrier, the clutch being engageable by movement of the drive plate from the second to the first condition. The clutch may be a cone clutch, or a parallel plate clutch.

By using the clutch to transfer torque from the input shaft directly to the planet carrier, the 1:1 ratio can be achieved without transferring any significant force through the planet gears. As such, they can be made smaller (they only need to support the load in the lower ratio condition).

Preferably the planet gears define a plurality of planet gear axes at a planet gear radius from the main axis of the planetary gear set, and in which the clutch comprises opposed mating surface which are at least partially radially outboard of the planet gear radius. More preferably the opposed mating surfaces of the clutch are fully radially outboard of the planet gear radius. This allows for better torque transfer through the clutch (torque being proportionate to radius).

Preferably the opposed mating surfaces are radially inboard of the ring gear outer radius, providing a compact arrangement.

According to a second aspect of the invention there is provided a method of operating an internal combustion engine cooling system comprising the steps of:

providing a coolant circuit comprising a coolant;

providing a coolant apparatus according to the first aspect;

providing an impeller attached to the output shaft and arranged to pump the coolant around the circuit;

driving the input shaft to pump the coolant around the circuit.

Preferable the method comprises the step of:

changing the condition of the gearbox to provide a different gear ratio and thereby alter the pumping effect of the coolant pump.

Preferably the method comprises the steps of:

providing an engine cooled by the coolant circuit;

monitoring a sensed property of the engine;

changing the condition of the gearbox dependent upon the sensed property.

Preferably, the sensed property is engine or coolant temperature, and the method comprises the step of changing the condition of the gearbox to provide a lower reduction gear ratio as the temperature increases. Advantageously, this reduces the speed of the impeller (and hence the volume of fluid being pumped) as the temperature of the engine reduces.

Preferably the input shaft is driven by the engine.

According to a third aspect of the invention there is provided an internal combustion engine coolant apparatus comprising:

an input shaft;

an output shaft configured to drive an impeller; and,

a gearbox between the input shaft and the output shaft, the gearbox comprising:

a planetary gear set configured to be driven by the input shaft, the gearbox being switchable between:

a first condition in which the planetary gear set has a first gear ratio; and,

a second condition in which the planetary gear set has a second ratio lower than the first; and,

an electrically powered actuator comprising an electromagnet configured to switch the gearbox between the first and second conditions.

The use of an electromagnetic provides a mechanically robust system which can also act with high speed to change the gear ratio.

Preferably the electromagnet is a solenoid.

Preferably the actuator is configured to drive a displaceable drive member from one of the first and second conditions, in which the drive member is resiliently biased to the other of the first and second conditions.

Preferably the actuator is configured to drive a displaceable drive member from the first to the second condition, in which the drive member is resiliently biased to the first condition.

Preferably the drive member is biased by a spring.

Preferably the drive member comprises a material responsive to a magnetic field.

Preferably the electromagnet is annular in shape, centred on a main axis of the gear set.

Preferably the drive member is non-rotatably but linearly moveably mounted relative to the input shaft.

Preferably the drive member is mounted relative to the input shaft via a spline.

Preferably the output shaft is driven by a planet carrier of the planetary gear set.

Preferably the apparatus comprises a clutch between the drive member and the planet carrier, the clutch being engageable by movement of the drive member from the second to the first condition.

Preferably the planet gears define a plurality of planet gear axes at a planet gear radius from the main axis of the planetary gear set, and in which the clutch comprises opposed mating surface which are at least partially radially outboard of the planet gear radius.

Preferably the opposed mating surfaces of the clutch are fully radially outboard of the planet gear radius.

Preferably the opposed mating surfaces are radially inboard of the ring gear outer radius.

Preferably the clutch is a cone clutch.

Preferably the clutch is a parallel plate clutch.

According to a fourth aspect of the invention there is provided a method of operating an internal combustion engine cooling system comprising the steps of:

providing a coolant circuit comprising a coolant;

providing a coolant apparatus according to the third aspect;

providing an impeller attached to the output shaft and arranged to pump the coolant around the circuit;

driving the input shaft to pump the coolant around the circuit.

Preferably the method comprises the steps of:

changing the condition of the gearbox to provide a different gear ratio and thereby alter the pumping effect of the coolant pump.

Preferably the method comprises the steps of:

providing an engine cooled by the coolant circuit;

monitoring a sensed property of the engine;

changing the condition of the gearbox dependent upon the sensed property.

Preferably the sensed property is temperature, comprising the step of:

changing the condition of the gearbox to provide a higher gear ratio as the temperature increases.

Preferably the input shaft is driven by the engine.

According to a fifth aspect of the present invention there is provided an internal combustion engine coolant apparatus comprising:

an input shaft;

an output shaft configured to drive an impeller; and,

a gearbox between the input shaft and the output shaft, the gearbox comprising:

a first planetary gear set configured to be driven by the input shaft; and,

a second planetary gear set configured to be driven by the first planetary gear set, and configured to drive the output shaft.

The provision of two planetary gearboxes in series allows for a high gear reduction ratio, with a very compact form. It simultaneously affords the ability to provide up to four selectable gear ratios to match the current cooling requirement. Planetary gear sets are also robust and very reliable with few losses.

Preferably the first and second planetary gear sets are both configured to provide a reduction gear ratio, which is advantageous if the apparatus is driven from the engine crankshaft, and allows significant speed reduction to reduce parasitic losses and for cold starting conditions.

The first and second planetary gear sets may have the same gear ratio, or different gear ratios. If the gearboxes can be selectively controlled, the same gearing allows three potential overall gearbox ratios, and different gearing allows four overall gearbox ratios.

Preferably the gearbox is provided with more than one selectable state, in which each state has a different gear ratio between the input shaft and output shaft. This allows the cooling effect and coolant flow to be controlled.

Preferably the first planetary gear set has more than one selectable state, in which each state has a different gear ratio. A first clutch may be arranged to switch between two of the more than one selectable states. Preferably the clutch is configured to selectively rotatably fix two of a sun gear, planet carrier and ring gear of the first planetary gear set. This allows a simple axial dog or friction plate clutch to be used.

Preferably the second planetary gear set has more than one selectable state, in which each state has a different gear ratio. This affords more choice of overall gearbox ratio. Preferably the gearbox comprises a second clutch arranged to switch between two of the more than one selectable states of the second planetary gear set. Preferably the second clutch is configured to selectively rotatably fix two of a sun gear, planet carrier and ring gear of the second planetary gear set.

Preferably the input shaft drives a sun gear of the first planetary gearbox. Preferably a planet carrier of the first planetary gear set drives a sun gear of the second planetary gear set and the planet carrier of the second planetary gear set drives the output shaft. This allows for a high reduction ratio (with fixed ring gears).

Preferably the sun gear and planet carrier of the first and/or second planetary gear set can be selectively rotationally fixed to provide a 1:1 ratio (for example by clutch).

Preferably the apparatus comprises a housing, in which a ring gear of the first and/or second planetary gear set is fixed to the housing by a clutch which permits rotation of the ring gear in a first rotational direction, but inhibits rotation of the ring gear in a second, opposite, rotational direction. A one-way clutch (for example a sprag clutch) may be used to achieve this. This means than when the sun and planet carrier gears are locked together, the ring gear can rotate to provide a 1:1 ratio.

Preferably a pulley is arranged to drive the input shaft, most preferably driven by an engine crankshaft via a belt.

The invention also provides an engine having a cooling circuit and a coolant apparatus according to the third aspect driving coolant around the cooling circuit. Preferably an engine control unit is provided, in which the coolant apparatus is a selectable ratio coolant apparatus, and in which the engine control unit is configured to select the selectable state of the coolant apparatus.

According to a sixth aspect of the invention there is provided a method of operating an engine cooling system comprising the steps of:

providing a coolant circuit comprising a coolant;

providing a coolant apparatus having an impeller arranged to pump the coolant around the circuit, the coolant apparatus comprising an input shaft, an output shaft driving the impeller, and a gearbox between the input shaft and the output shaft, the gearbox comprising a first planetary gear set configured to be driven by the input shaft and a second planetary gear set configured to be driven by the first planetary gear set, and configured to drive the output shaft;

driving the input shaft to pump the coolant around the circuit.

Preferably the gearbox is provided with more than one selectable state, in which each state has a different gear ratio between the input shaft and output shaft, the method comprising the steps of:

changing the state of the gearbox to provide a different gear ratio and thereby alter the pumping effect of the coolant pump.

Preferably the method comprises the steps of:

providing an engine cooled by the coolant circuit;

monitoring a sensed property of the engine;

changing the state of the gearbox dependent upon the sensed property.

Preferably which the sensed property is temperature, the method comprising the step of:

changing the state of the gearbox to provide a lower reduction gear ratio as the temperature increases to increase flow as engine temperature increases.

In some embodiments, the IC engine may be provided in a vehicle. In other embodiments, the IC engine may form part of a generator.

### BRIEF DESCRIPTION OF THE DRAWINGS

Example engines and coolant pumps will now be described with reference to the accompanying drawings in which:

FIG. 1 is a schematic of part of a coolant circuit and a first coolant pump assembly in accordance with the present invention;

FIG. 2a is a first outer view of the coolant pump of FIG. 1;

FIG. 2b is a second outer view of the pump of FIG. 2a;

FIG. 3 is a section view of the coolant pump of FIG. 2a along line III-III;

FIG. 4 is a section view of the coolant pump of FIG. 2a along line IV-IV;

FIG. 5 is a cutaway view of the coolant pump of FIG. 3 along line V-V;

FIG. 6 is a cutaway view of the coolant pump of FIG. 3 along line VI-VI;

FIG. 7 is a cutaway view of the coolant pump of FIG. 2a along line VII-VII;

FIG. 8a a is a cutaway view of the coolant pump of FIG. 3 along line VIII-VIII(A);

FIG. 8b a is a cutaway view of the coolant pump of FIG. 3 along line VIII-VIII(B);

FIG. 9a is a schematic of a part of the coolant pump of FIG. 3 in a first state;

FIG. 9b is a schematic of a part of the coolant pump of FIG. 3 in a second state;

FIG. 9c is a schematic of a part of the coolant pump of FIG. 3 in a third state;

FIG. 9d is a schematic of a part of the coolant pump of FIG. 3 in a fourth state;

FIG. 10 is a schematic of part of a coolant circuit and a second coolant pump assembly in accordance with the present invention;

FIG. 11 is an outer view of the coolant pump of FIG. 10;

FIG. 12 is a section view of the coolant pump of FIG. 10 along line XII-XII;

FIG. 13a is a schematic of a part of the coolant pump of FIG. 10 in a first state; and,

FIG. 13b is a schematic of a part of the coolant pump of FIG. 10 in a second state.

### DETAILED DESCRIPTION OF THE INVENTION

Referring to FIG. 1, an IC engine coolant circuit 10 is arranged to convey a liquid coolant 12 from a heat source in the form of engine component 14 to a radiator 16. The liquid coolant 12 is recirculated in the circuit 10. The engine 14 is controlled by an electronic engine control unit (ECU) 18, as known in the art.

A coolant pump 100 comprises an input shaft 102 on which a driven pulley 104 is mounted. The input shaft 102 drives a gearbox 106. An output shaft 108 extends from the gearbox 106 to an impeller 110. The impeller is arranged to pump the coolant 12 around the circuit 10.

The ECU 18 is configured to provide command signals to the gearbox via data line 112 as will be described below.

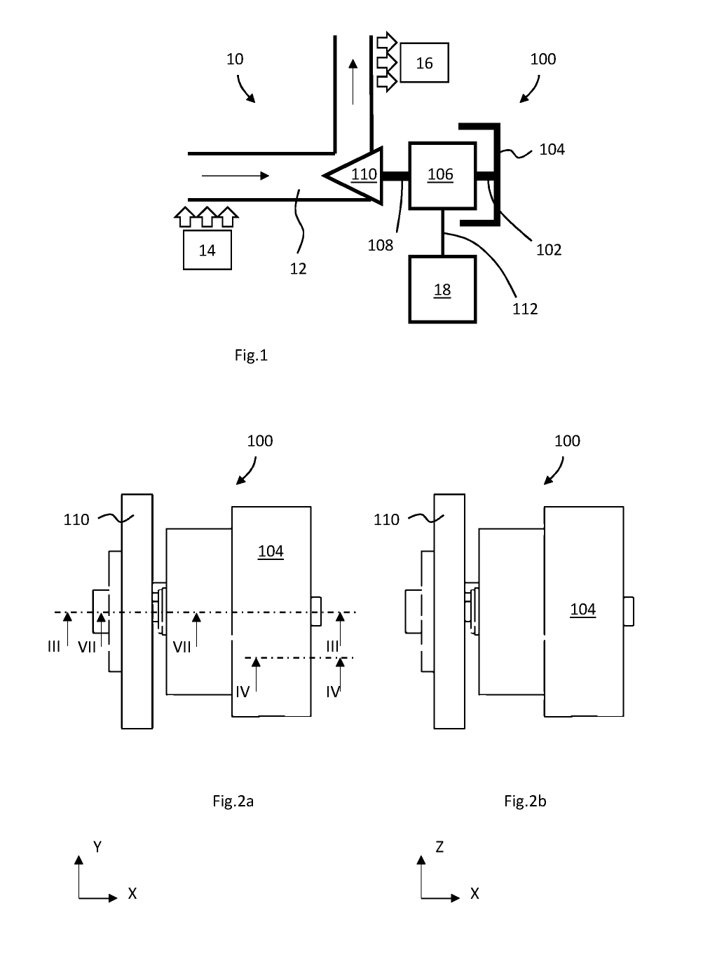

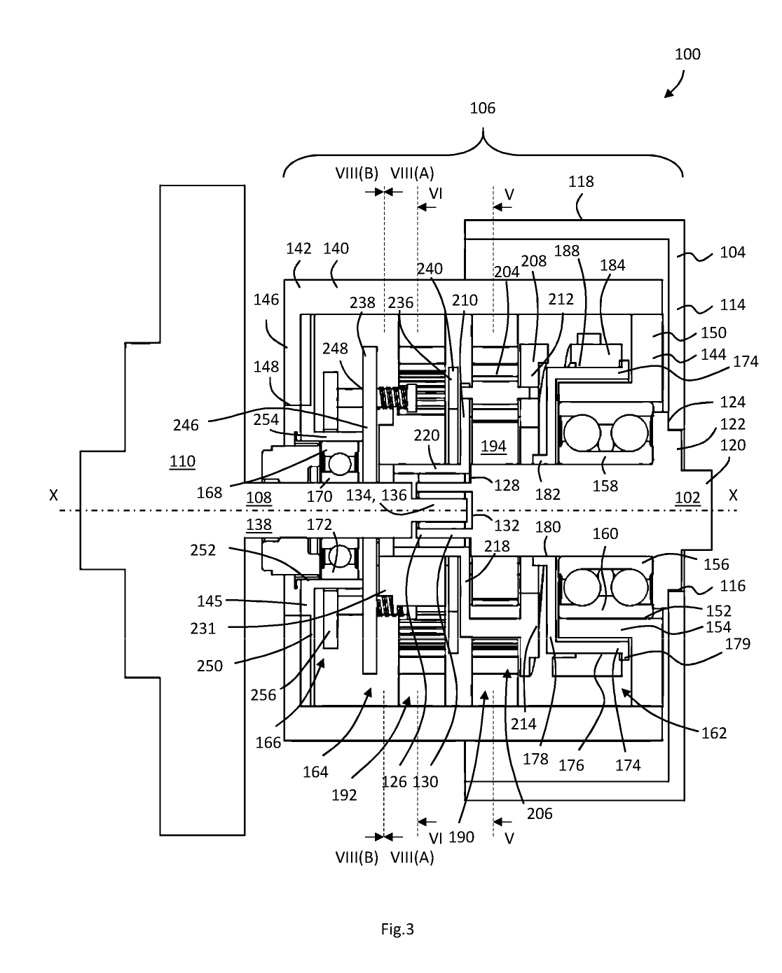

The coolant pump 100 is shown in FIGS. 2a and 2b. Referring to FIG. 3, the coolant pump 100 is shown in more detail.

The input shaft 102 is a solid cylindrical component having a first end 120. Proximate the first end 120, there is provided an annular collar 122 having a shoulder 124 facing the first end 120. At a second end 126 of the input shaft 102 there is provided a shoulder 128 leading to a smaller diameter section 130 which comprises a central bore 132.

The pulley 104 is an open, cylindrical body with one closed end wall 114 having a central shaft engagement formation 116. The pulley 104 defines a cylindrical outer surface 118 which is contacted and driven by a belt (not shown) in use.

The output shaft 108 is shown as being unitary with the impeller 110, although this is merely a schematic and they will usually be separate components for ease of assembly and replacement. The output shaft 108 is a solid cylindrical component having a first end 134 defining a smaller diameter stub shaft 136. The impeller 110 is positioned at a second end 138 of the output shaft 108.

The gearbox 106 comprises a housing 140, a first operable clutch 162, a gear set 164, a second operable clutch 166, an input shaft bearing 156 and an output shaft bearing 168.

The housing 140 comprises a first housing part 142, a second housing part 144 and a support member 145. The first housing part 142 is hollow and generally cylindrical, having an end wall 146. The end wall 146 defines a central bore 148. The second housing part 144 defines an annular wall 150 having a central bore 152. A cylindrical portion 154 extends from the central bore 152. The support member 145 is a unitary component with an annular plate section 250 having a bore 252 therethrough and a cylindrical section 254 extending from the bore. The outer diameter of the plate section 250 fits within the first housing part 142 and abuts the end wall 146 such that the cylindrical section 254 extends into the housing. The outer diameter of the annular wall 150 is sized for a press fit with the inner diameter of the first housing part 142. In this way, the housing parts can be assembled to form a closed chamber containing the support member 145.

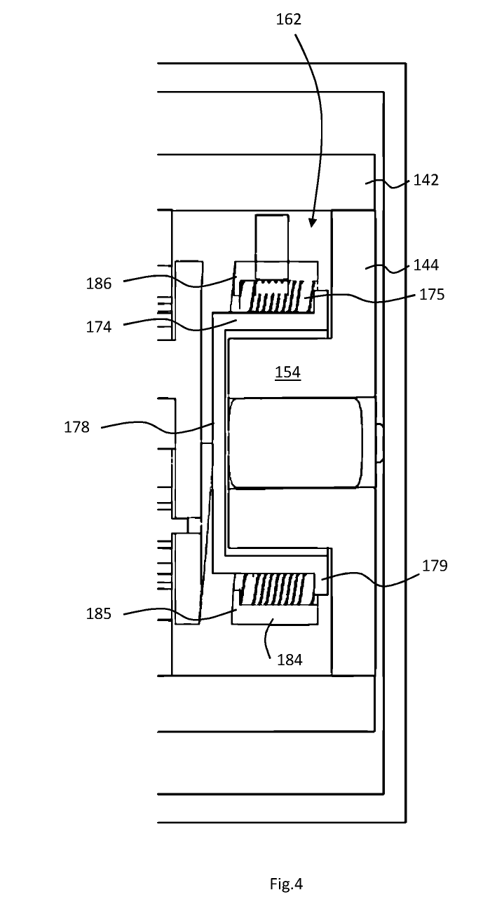

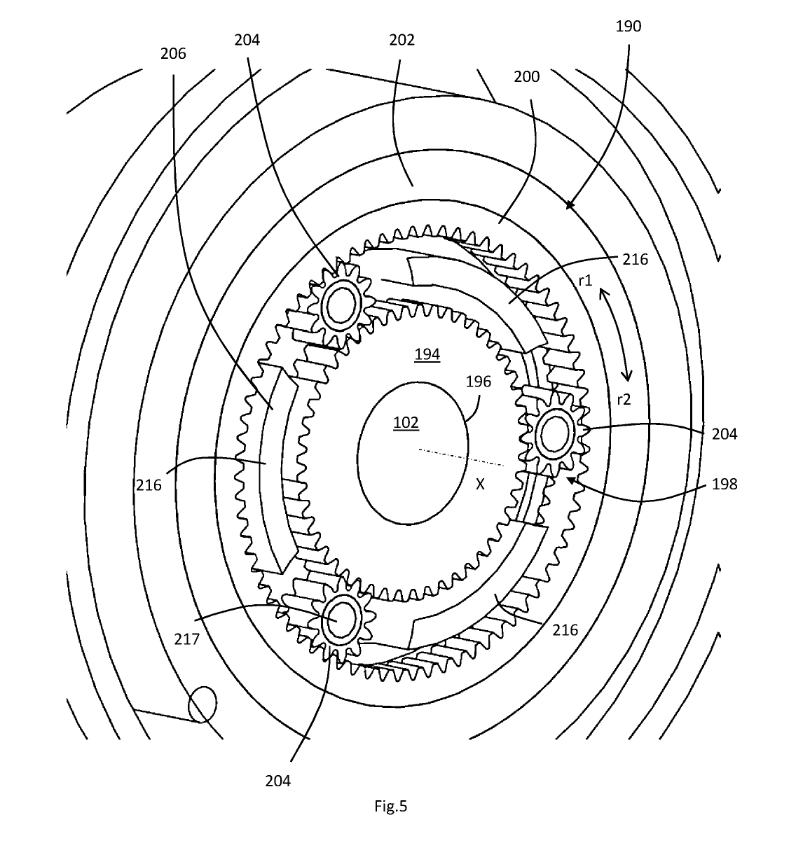

The first operable clutch 162 comprises a splined shaft 174, and a first clutch sleeve 184. The splined shaft 174 is generally cylindrical having an outer spline 176 and an end wall 178. A bore 180 is provided in the centre of the end wall 178 having an axially extending hollow stub shaft 182 extending therefrom. At the opposite end of the splined shaft 174 to the end wall 178 there is provided a radially outwardly extending annular flange 179. The first clutch sleeve 184 is a hollow cylindrical shaft having an end wall 185 with a clutch formation 186 on a first end comprising a plurality of ramped teeth. On a radially inner side of the first clutch shaft, there is provided an inner spline 188. In this way, the inner spline 188 of the first clutch sleeve 184 can be engaged with the outer spline 176 of the splined shaft such that the two components can move axially relative to each other but are rotationally fixed. Referring to FIG. 4, the splined shaft 174 and the first clutch sleeve 184 are provided with a series of resilient elements in the form of compression springs 175 therebetween. The springs bear on the inner surface of the end wall 185 and the flange 179 to urge the first clutch sleeve 184 to the left in FIG. 4.

The gear set 164 comprises a first planetary gear set 190 and a second planetary gear set 192.

The first planetary gear set 190 is best shown viewing FIGS. 3 and 5 together. The first planetary gear set 190 comprises a sun gear 194, a planet gear assembly 198, a ring gear 200 and a ring gear clutch 202.

The sun gear 194 is a spur gear having a toothed outer as known in the art. The sun gear has S1 teeth and a central bore 196. The planet gear assembly 198 comprises three planet gears 204 (each of which are spur gears). The planet gears 204 are carried on a planet carrier 206 having a first side 208 and a second side 210. The first side 208 of the planet carrier 206 comprises an annular ring 212 having a clutch formation 214 comprising a plurality of ramped teeth defined on one side thereof. Opposite the clutch formation 214 there are provided a series of three spaced apart, axially extending circle segment supports 216 and planet gear shafts 217. The second side 210 of the planet carrier comprises an annular ring 218 which has an axially extending shaft 220 defined thereon. The ring gear 200 is an internal spur gear having R1 teeth. The ring gear clutch 202 is a one way clutch which permits rotation of the ring gear in a first direction r1 but inhibits rotation in opposite rotation direction r2.

The sun gear 194 is rotatable about the axis X, and its teeth are engaged with each of the planet gears 204. The planet gears are carried by the planet carrier, which is positioned with the first side 208 and second side 210 positioned on opposite sides of the sun gear. The first and second sides 208, 210 are joined by the supports 216 and the planet gear shafts 217 on which the planet gears 204 can rotate. The planet gears 204 are also meshed with the ring gear 200.

In this embodiment,

$$\frac{R 1}{S 1} = 1.5 ,$$

which provides a 1:

$$\frac{1}{1 + \frac{R 1}{S 1}} = 1 \text{:} 0.4$$

reduction from the sun gear to the planet carrier.

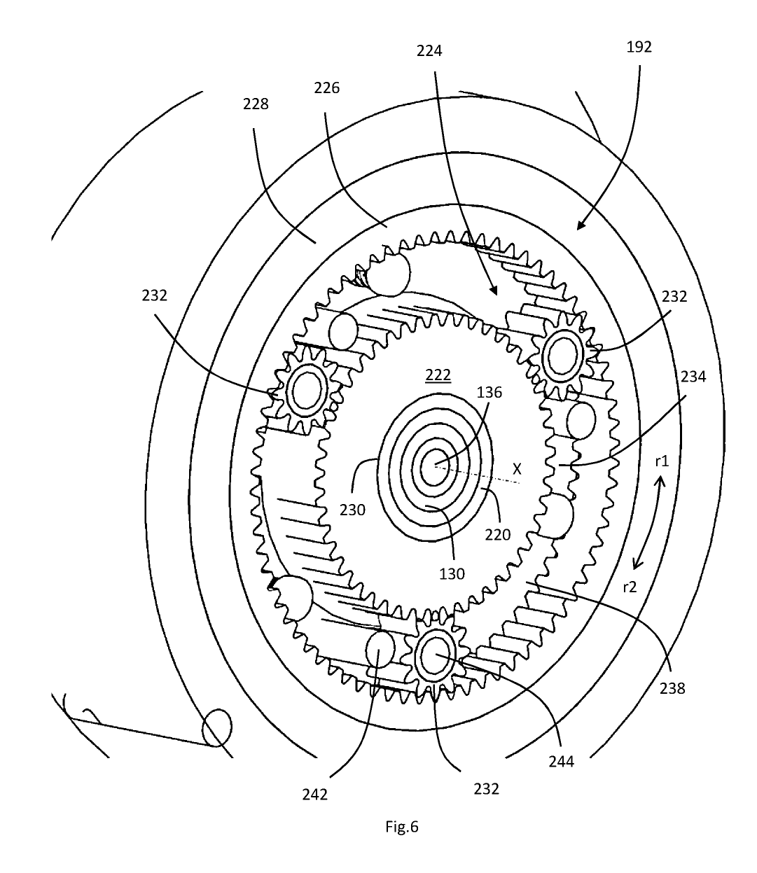

The second planetary gear set 192 is best shown viewing FIGS. 3 and 6 together. The second planetary gear set 192 comprises a sun gear 222, a planet gear assembly 224, a ring gear 226 and a ring gear clutch 228.

The sun gear 222 is a spur gear having a toothed outer as known in the art. The sun gear has S2 teeth and a central bore 230. The sun gear also defined a dog clutch formation 231. The planet gear assembly 224 comprises three planet gears 232 (each of which are spur gears). The planet gears 232 are carried on a planet carrier 234 having a first side 236 and a second side 238. The first side 236 of the planet carrier 234 comprises an annular ring 240. The first side defines series of three spaced apart, axially extending supports 242 and planet gear shafts 244. The second side 238 of the planet carrier comprises an annular ring 246 having a plurality of open bores 248 defined therethrough. The supports 242 hold the first side 236 and second side 238 in a fixed, spaced-apart relationship. The ring gear 226 is an internal spur gear having R2 teeth. The ring gear clutch 228 is a one-way clutch which permits rotation of the ring gear 226 in the first direction r1 but inhibits rotation in the opposite rotation direction r2.

The sun gear 222 is rotatable about the axis X, and its teeth are engaged with each of the planet gears 232. The planet gears 232 are carried by the planet carrier 234, which is positioned with the first side 236 and second side 238 positioned on opposite sides of the sun gear 222. The first and second sides 236, 238 are joined by the supports 242 and the planet gear shafts 244 on which the planet gears 232 can rotate. The planet gears 232 are also meshed with the ring gear 226.

In this embodiment,

$$\frac{R 2}{S 2} = 1.5 ,$$

which provides a 1:

$$\frac{1}{1 + \frac{R 2}{S 2}} = 1 \text{:} 0.4$$

reduction from the sun gear to the planet carrier.

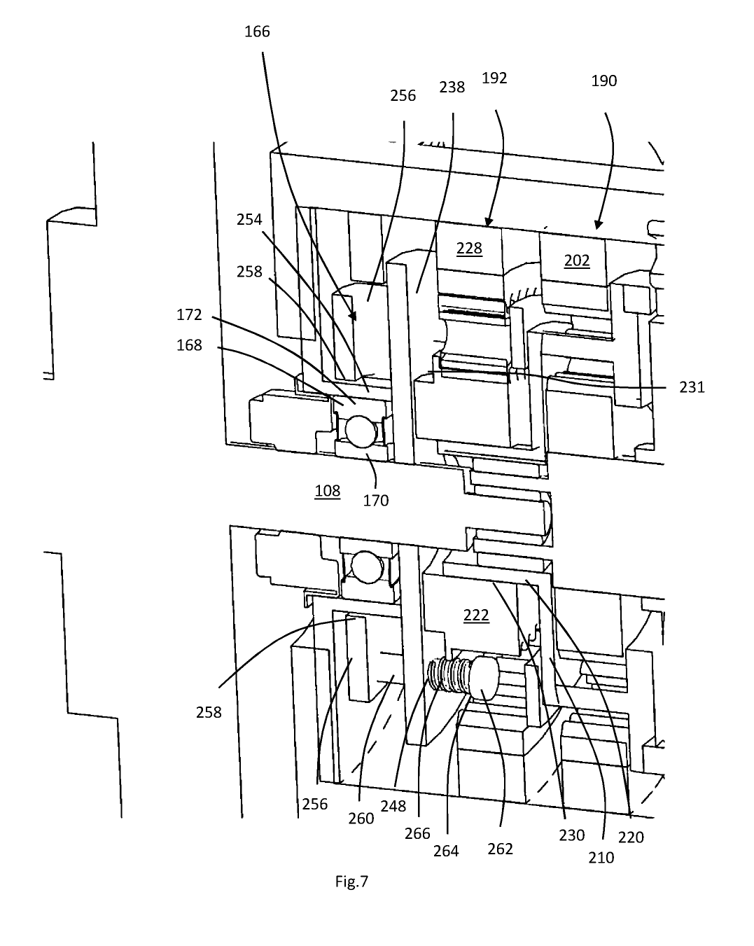

Referring to FIGS. 3 and 7, the second operable clutch 166 comprises a sliding engagement plate 256 having a central bore 258. The sliding engagement plate 256 has three axially extending spring supports 260 and three engagement pins 261 extending axially therefrom. Each spring support 260 has a larger diameter end abutment 262 defining a shoulder 264 facing the sliding engagement plate 256. Compression springs 266 are provided on each support 260 and abut the shoulder 264. The engagement pins 261 are spaced between the spring supports 260.

The input shaft bearing 156 is a double row angular contact ball bearing assembly, and has an inner shaft 158 and an outer shaft 160 which are relatively rotatable.

The output shaft bearing 168 is a single row deep groove ball bearing assembly, and has an inner shaft 170 and an outer shaft 172.

The coolant pump is assembled as follows.

Referring to FIG. 7, the outer shaft 172 of the output shaft bearing 168 is fitted into the cylindrical section 254 of the housing support member 145. The output shaft 108 is fitted into the inner shaft 170 of the output shaft bearing 168.

The sliding engagement plate 256 of the second operable clutch 166 is aligned with the cylindrical section 254 of the housing support member 145 through its bore 258. The sliding engagement plate 256 can slide in an axial fashion and rotate.

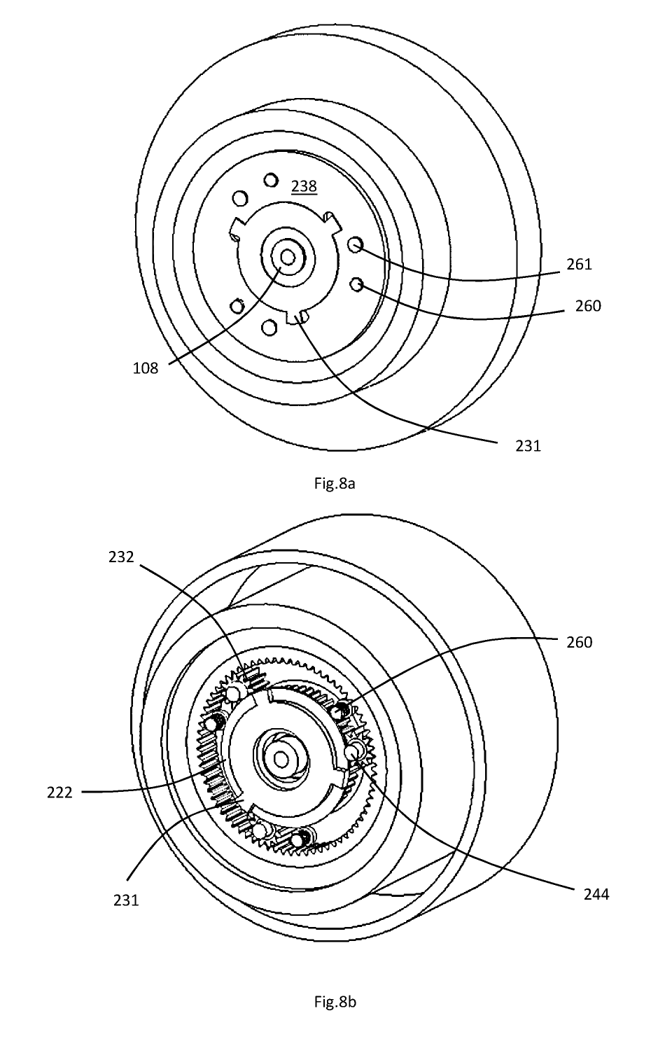

The second planetary gear set 192 is provided with the second side 238 of the planet carrier fixed to the outer diameter of the output shaft 108. The spring supports 260 and the engagement pins 261 of the sliding engagement plate 256 of the second operable clutch 166 pass through the bores 248 in the second side 238 of the planet carrier. This is shown in FIG. 8a. The springs 266 bear against the second side 238 of the planet carrier to are arranged to urge the abutments 262 (and hence the engagement plate 256) to the right in FIG. 3.

The ring gear clutch 228 is fitted against the inner surface of the first housing part 142.

The first planetary gear set 190 is provided with the shaft 220 of the second side 210 of the planet carrier 206 engaged in the inner bore 230 of the sun gear 222 of the second planetary gear set 192. In this way, the planet carrier 206 of the first planetary gear set 190 rotated with the sun gear 222 of the second planetary gear set 192.

The ring gear clutch 202 is fitted against the inner surface of the first housing part 142.

Referring to FIG. 4, the first operable clutch 162 is provided with the splined shaft 174 having the cylindrical portion 154 of the second housing part 144 nested within (although they are not in contact).

The input shaft 102 is provided with the bore 132 of the smaller diameter section 130 receiving the stub shaft 136 of the output shaft 108. The sun gear 194 is fixed to the input shaft so they rotate together. Further, the splined shaft 174 of the first operable clutch 162 is rotatably fixed to the input shaft 102. The input shaft 102 is rotatably mounted to the housing 140 via the input shaft bearing 156. The inner shaft 158 receives the input shaft 102, whilst the outer shaft 160 is non-rotatably received in the bore 152 of the second housing part 144.

The central shaft engagement formation 116 of the pulley 104 receives the input shaft 102 (and is fixed thereto) and extends towards the impeller 110 to partially enclose the housing 140.

The coolant pump is operated as follows.

Both the first clutch sleeve 184 of the first operable clutch, and the engagement plate 256 of the second planet carrier 234 are movable in an axial direction by a gear selection apparatus. Such apparatuses are well known in the art, and will not be described here. All that is required for an understanding of the invention is that an axial force may be selectively applied to the first clutch sleeve 184 in a direction away from the first planetary gear set 190, and an axial force may be applied to the engagement plate 256 in a direction away from the second planetary gear set 192 (to the left in FIG. 3). The apparatuses are controlled by the data line 112 from the ECU 18.

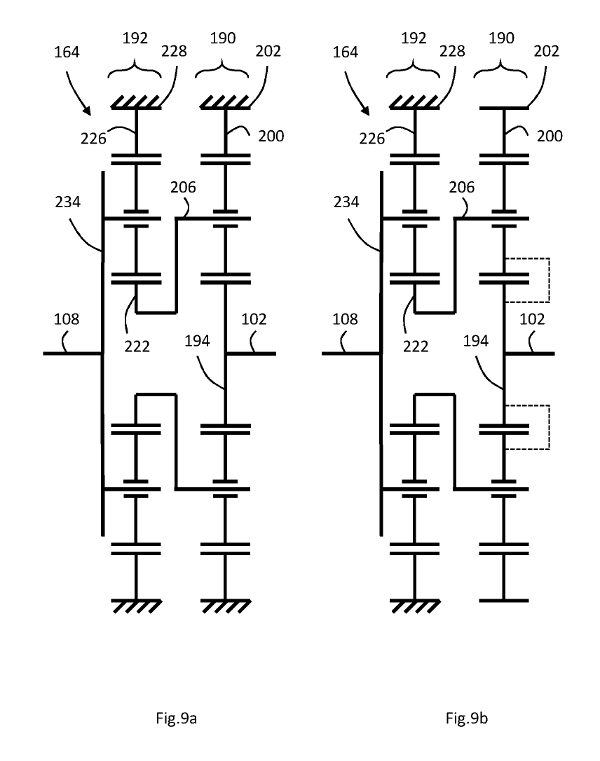

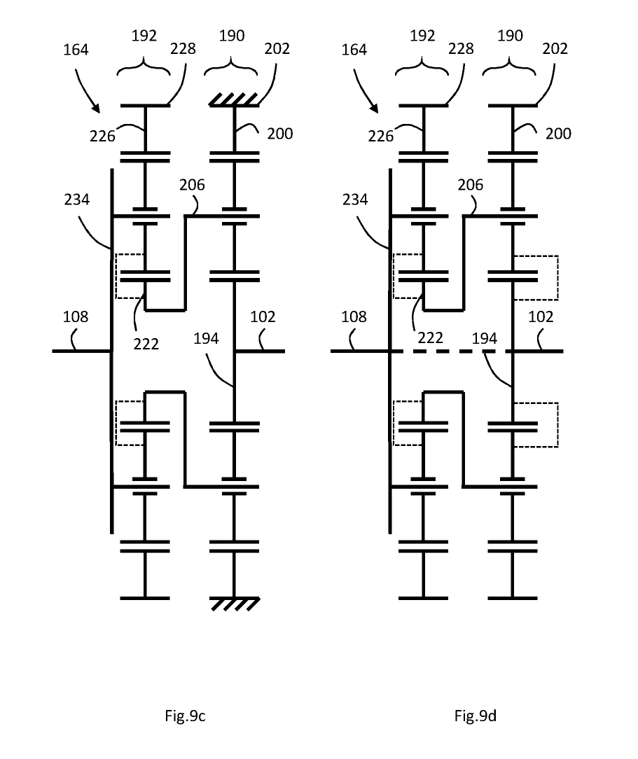

In a first state, both operable clutches are disengaged. This is shown schematically in FIG. 9a. The springs 175 of the first operable clutch 162 are compressed by movement of the first clutch sleeve 184 to the right in FIG. 4 which means that relative rotation of the clutch sleeve 184 and planet carrier 206 is permitted. The springs 266 of the second operable clutch 166 are compressed by forcing the engagement plate to the left in FIG. 3.

A torque in direction r1 at the input shaft 102 via pulley 104 drives the sun gear 194 of the first planetary gear set 190 in direction r1 (FIG. 5). This drives the planet gears 204 and rotates the planet carrier 206 in direction r1. The clutch 202 inhibits rotation of the ring gear 200 because the resulting (reaction) torque is in direction r2.

Rotation of the planet carrier 206 of the first planetary gear set 190 rotates the sun gear 222 of the second planetary gear set 192 in direction r1 (FIG. 6). This rotates the planet gears 232 which process around the sun gear 222 to rotate the planet carrier 234. The clutch 228 inhibits rotation of the ring gear 226 because the resulting (reaction) torque is in direction r2.

Rotation of the planet carrier 234 of the second planetary gear set 192 rotates the output shaft 108, and hence the impeller 110.

In this first state, the rotation of the pulley 104 (and input shaft 102) is passed through both planetary gear sets 190, 192 to provide a reduction gear ration to the output shaft 108 and impeller 110. The ratio is the product of the ratios of the first and second gear sets—i.e. 1:

$$\frac{1}{1 + \frac{R 1}{S 1}} \times \frac{1}{1 + \frac{R 2}{S 2}} = 1 \text{:} 0.4 \times 0.4 = 1 \text{:} 0.16 .$$

In a second state (shown schematically in FIG. 9b), the first operable clutch 162 is engaged by releasing the first clutch shaft to engage the planet carrier 206 of the first gear set 190 (the second operable clutch remains disengaged). This provides a rotational lock between the sun gear 194 and the planet carrier 206 of the first gear set 190 (the dotted line in FIG. 8b). As such, the first gear set adopts a 1:1 ratio, and the ratio of the overall gearbox is determined by the second gear set only (i.e. 1:0.4). It will be noted that rotation of the sun and planet carrier of the first gear set needs to take place. This is permitted because the resulting torque on the ring gear changes direction from r2 to r1, and as such the clutch permits rotation of the ring gear with the sun and planet carrier in direction r1.

In a third state (shown schematically in FIG. 9c), the second operable clutch 166 is engaged by releasing the engagement plate 256. The springs 266 extend, pulling the engagement pins 261 through the second side 238 of the planet carrier 234 (FIG. 8a) to engage the dog clutch 231 (FIG. 8b). This provides a rotational lock between the sun gear 222 and the planet carrier 234 of the second gear set 192 via the engagement plate 256 (represented by the dotted line in FIG. 8b). As such, the second gear set adopts a 1:1 ratio. In this third state, the first operable clutch 162 is disengaged and therefore the ratio of the overall gearbox is determined by the first gear set only (i.e. 1:0.4). It will be noted that rotation of the sun and planet carrier of the second gear set needs to take place. This is permitted because the resulting torque on the ring gear changes direction from r2 to r1, and as such the clutch permits rotation of the ring gear with the sun and planet carrier in direction r1.

In a fourth state, shown in FIG. 9d, both operable clutches 162, 166 are released and therefore engaged, and the gearbox adopts a 1:1 ratio. This is the “failsafe” condition in which the maximum coolant flow is provided, albeit at the expense of energy use.

The four states can be summarized as follows:

| State | First clutch | Second clutch | Ratio |
|---|---|---|---|
| 1 (FIG. 8a) | Disengaged | Disengaged | 1:0.16 |
| 2 (FIG. 8b) | Engaged | Disengaged | 1:0.4 |
| 3 (FIG. 8c) | Disengaged | Engaged | 1:0.4 |
| 4 (FIG. 8d) | Engaged | Engaged | 1:1 |

Evidently for this embodiment the engine ECU needs only select the second or third state (because they produce the same gear ratio).

In use, when the engine is warming up, it is desirable to reduce the speed of the impeller 110 to reduce thermal transfer in a cold engine (to allow the engine to warm up). Thus, state 1 can be selected to provide a low flow rate around the circuit 10.

As the engine warms up, the ECU will detect this (via an appropriate sensor) and state 2 (or 3) can be selected (decreasing the reduction ratio) to provide a steady state cooling effect under normal engine running conditions.

When the engine is being driven hard, the temperature may increase significantly—at which point state 4 can be selected to significantly increase cooling.

When the impeller 110, running in states 1, 2 or 3 provides sufficient cooling for the current conditions, the ECU will select these in preference to state 4. This will provide increased efficiency and therefore fuel saving.

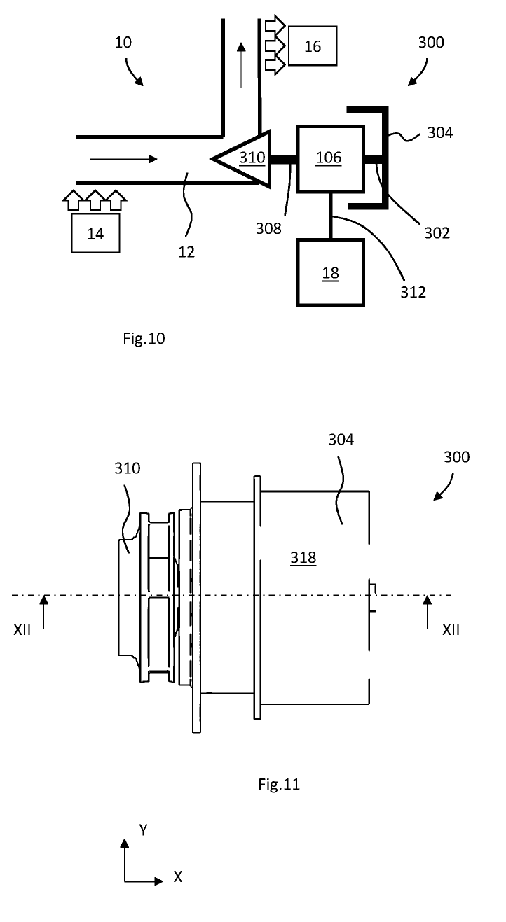

Referring to FIG. 10, as with FIG. 1 an IC engine coolant circuit 10 is arranged to convey a liquid coolant 12 from a heat source in the form of engine component 14 to a radiator 16. The liquid coolant 12 is recirculated in the circuit 10. The engine 14 is controlled by an electronic engine control unit (ECU) 18, as known in the art.

A coolant pump 300 comprises an input shaft 302 on which a driven pulley 304 is mounted. The input shaft 302 drives a gearbox 306. An output shaft 308 extends from the gearbox 306 to an impeller 310. The impeller is arranged to pump the coolant 12 around the circuit 10.

The ECU 18 is configured to provide command signals to the gearbox via data line 312 as will be described below.

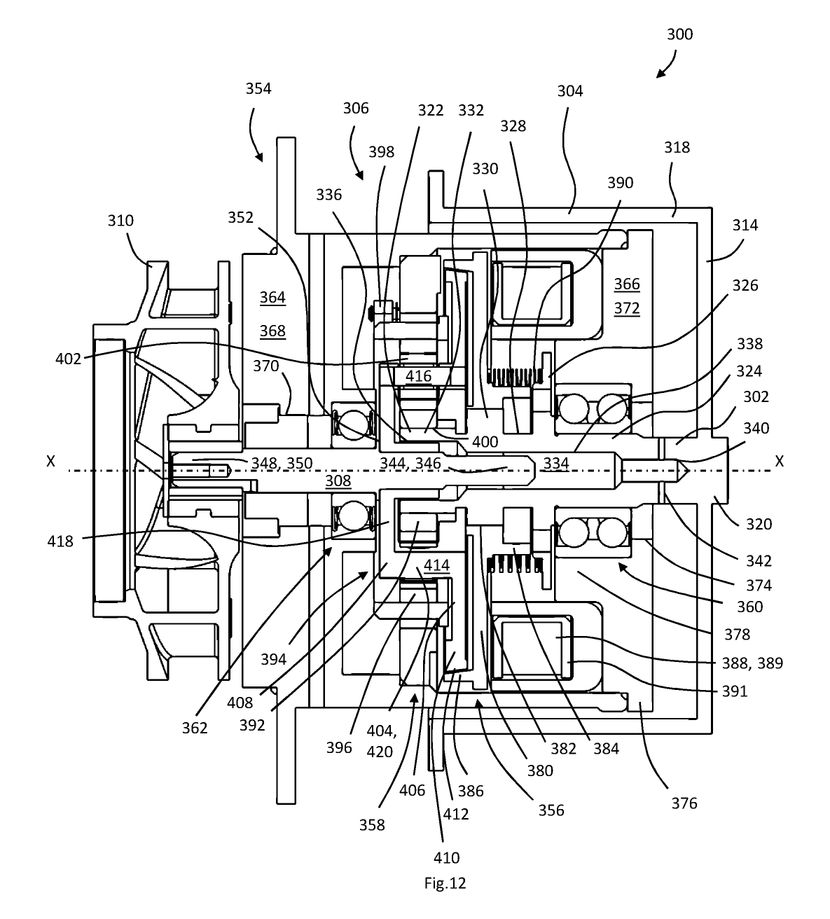

The coolant pump 300 exterior is shown in FIG. 11. Referring to FIG. 12, the coolant pump 300 is shown in more detail and in section.

The input shaft 302 and the pulley 304 are unitary. The input shaft 302 has a first end 320 (from which the pulley 304 extends) and a second end 322 opposite the first.

Moving from the first end 320 to the second end 322, there is provided a bearing contact region 324 which leads to an annular flange 326. Adjacent the annular flange 326 there is provided a recess 328 leading to a splined shaft portion 330. Adjacent the splined shaft portion 330, at the second end 322 of the input shaft 302, there is provided a sun gear shaft portion 332.

The input shaft 302 defines a blind bore 334 therethrough, comprising a first portion 336 at the second end 322, stepping down to a lower diameter second portion 338 and finally to a lowest diameter third portion 340 where radial vent holes 342 are provided.

The pulley 304 is an open, cylindrical body with one closed end wall 314 connected to the first end 320 of the shaft 302. The pulley 304 defines a cylindrical outer surface 318 (FIG. 11) which is contacted and driven by a belt (not shown) in use.

The output shaft 308 is a solid cylindrical component having a first end 344 defining a first stub shaft 346 and a second end 348 defining a second stub shaft 350. The output shaft 308 defines an annular flange 352.

The gearbox 306 comprises a housing 354, a clutch 356, a gear set 358, an input shaft bearing 360 and an output shaft bearing 362.

The housing 354 comprises a first housing part 364 and a second housing part 366. The first housing part 364 is hollow and generally cylindrical, having an end wall 368. The end wall 368 defines a central bore 370. The second housing part 366 defines an annular wall 372 having a central bore 374 and a peripheral shoulder 376. A cylindrical portion 378 extends from the central bore 374. The outer diameter of the annular wall 372 is sized for a press fit with the inner diameter of the first housing part 364. In this way, the housing parts can be assembled to form a closed chamber.

The clutch 356 comprises a disc-like drive plate 380, a solenoid 388 a compression spring 390 and the annular ring of the planet carrier 410. The drive plate 380 is generally annular having a splined bore 382. An inner shaft portion 384 extends from one side of the drive plate 380. A first clutch formation 386 extends from the rim of the drive plate 380 in a direction opposite to the inner shaft portion 384, and defines a conical friction surface on a radially inwardly facing surface thereof.

The solenoid 388 comprises a magnetic coil 389 inside a steel case 391 which can be selectively energised to create a magnetic field to attract the drive plate 380. The compression spring 390 holds the drive plate 380 away from the solenoid 388 unless it is energised (as will be described below).

The gear set 358 is a planetary gear set. It comprises a sun gear 392, a planet gear assembly 394, a ring gear 396 and a ring gear clutch 398.

The sun gear 392 is a spur gear having a toothed outer as known in the art. The sun gear has S1 teeth and a central bore 400. The planet gear assembly 394 comprises three planet gears 402 (each of which is a spur gear). The planet gears 402 are carried on a planet carrier 404. The planet carrier 404 has a first side 406 and a second side 408. The first side 406 of the planet carrier 404 comprises an annular ring 410 having a second clutch formation 412, defining an external conical friction surface thereon. Opposite the second clutch formation 412 and joining the first and second sides 406, 408 there are provided a series of three spaced apart, axially extending circle segment supports 414 and planet gear shafts 416. The second side 410 of the planet carrier comprises an annular ring 418 which has an axially extending shaft 420 defined thereon. The ring gear 396 is an internal spur gear having R1 teeth. The ring gear clutch 398 is a one way clutch which permits rotation of the ring gear in a first direction but inhibits rotation in opposite rotation direction.

The sun gear 392 is rotatable about the axis X, and its teeth are engaged with each of the planet gears 402. The planet gears are carried by the planet carrier, which is positioned with the first side 406 and second side 408 positioned on opposite sides of the sun gear. The first and second sides 406, 408 are joined by the supports 414 and the planet gear shafts 416 on which the planet gears 402 can rotate. The planet gears 402 are also meshed with the ring gear 396.

In this embodiment,

$$\frac{R 1}{S 1} = 1.5 ,$$

which provides a 1:

$$\frac{1}{1 + \frac{R 1}{S 1}} = 1 \text{:} 0.4$$

reduction from the sun gear to the planet carrier.

The input shaft bearing 360 is a double row angular contact ball bearing assembly.

The output shaft bearing 362 is a single row deep groove ball bearing assembly.

The coolant pump is assembled as follows.

Referring to FIG. 12, the output shaft bearing 362 is fitted into the first housing part 364 and the output shaft 308 is fitted into the bearing 362 to allow relative rotation of the shaft 308 and housing part 364. The output shaft 308 extends through the central bore 370 of the first housing part 364 external to the housing 354 such that the impeller 310 may be attached thereto.

The gear set 358 is attached to the output shaft 308 by fixing the shaft 420 of the planet carrier 404 onto the output shaft 308. The clutch 358 is fixed into the first housing part 354 to inhibit rotation of the ring gear relative thereto in one rotational direction, but not the other.

The clutch drive plate 380 is axially slidably mounted to the input shaft 302 by engagement of the splined shaft portion 330 of the latter with the splined bore 382 of the former. This allows relative axial movement, but inhibits relative rotational movement, allowing torque to be transferred from the input shaft 302 to the clutch drive plate 380. The compression spring 390 is positioned between the flange 326 of the input shaft 302 and the facing surface of the drive plate 380 to urge the two components apart.

The input shaft 302 is assembled to the gear set 358 such that the sun gear 392 is fixed to the sun gear shaft portion 332. It will also be noted that the stub shaft 346 of the output shaft 308 extends within the blind bore 334 of the input shaft 302. The first clutch formation 386 provided on the clutch drive plate 380 is aligned with the second clutch formation 412 on the planet carrier 404 such that axial motion of the former can engage and disengage the clutch. The clutch formed by the two formations 386, 412 is a cone clutch.

The solenoid 388 is attached to the second housing part 366 and is positioned proximate the clutch drive plate 380. The input shaft 302 is assembled to the second housing part 366 for rotation relative thereto via the input shaft bearing 360.

The coolant pump is operated as follows.

The solenoid 388 can be selectively energised (by a local controller, or directly by the ECU 18) to magnetically attract the drive plate 380 to disengage the first and second clutch formations 386, 412. De-energization of the solenoid 388 results in the drive plate 380 and thereby the second clutch formation 412 moving to engage the first clutch formation 386. When the clutch is engaged, the drive plate 380 and planet carrier 404 are non-rotatably fixed together. When the clutch is disengaged, the drive plate 380 and planet carrier 404 are free to rotate relative to one another.

In an engaged state of the clutch, the input shaft 302 is driven by a belt engaged with the pulley 304. This in turn drives the drive plate 380 via the splined shaft portion 330 and the sun gear 392 via the sun gear shaft portion 332. The ring gear 396 is driven by the planet gears 402 to rotate in the same direction as the input shaft 302 (the clutch 356 allows this rotation in a first direction).

Because the planet carrier 404 is non-rotatably attached to the output shaft 308, the output shaft 308 is directly driven at a 1:1 ratio from the input shaft 302. It will be noted that this is the “failsafe” condition in which the highest possible gear ratio (providing the highest engine cooling effect) is provided. This failsafe condition is entered into upon deliberate or other loss of power to the solenoid 388.

Once the solenoid 388 is energised, the drive plate 380 is pulled away from the planet carrier 404 to disengage the clutch formations.

In this condition, rotation of the input shaft 302 from the pulley 304 effects rotation of the drive plate 380 via the splined shaft portion 330 and the sun gear 392 via the sun gear shaft portion 332. Because the drive plate 380 is no longer engaged with the planet carrier 404, the gear set 358 is only driven by a single load path—i.e. the rotation of the sun gear 392. Rotation of the sun gear 358 acts to drive the planet gears 402 in rotation about their respective shafts 420. Because the resulting reaction force on the ring gear 396 is in the opposite direction to the rotation of the input shaft 302, the ring gear clutch 398 prevents rotation thereof, holding the ring gear 396 in a stationary position. As a result, the planet gears 402 process around the axis of the rotating sun gear 392, thus effecting rotation of the planet carrier 404 in the same direction, but at a reduced speed (i.e. a reduction gear ratio) compared to the input shaft 302. Because the planet carrier 404 is engaged with the output shaft 308, the output shaft also rotates to rotate the impeller 310 but at a ratio of 40% of the input gear speed.

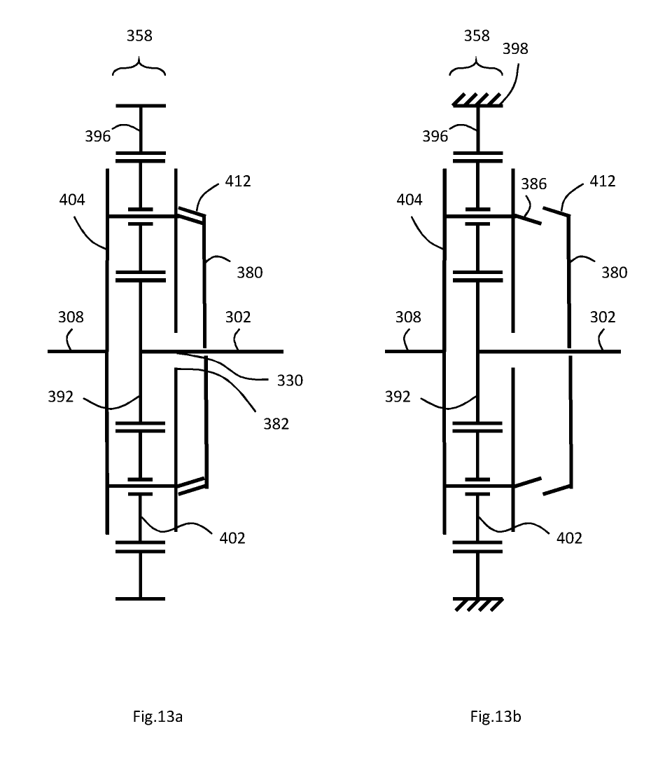

The two states can be summarized as follows:

| State | Clutch | Ratio |
|---|---|---|
| 1 (FIG. 13a) | Engaged | 1:1 |
| 2 (FIG. 13b) | Disengaged | 1:0.4 |
| | (solenoid | |
| | energised) | |

As the engine warms up, the ECU will detect this (via an appropriate sensor) and state 1 can be selected (decreasing the reduction ratio) to provide a steady state cooling effect under normal engine running conditions.

When the engine is being driven hard, the temperature may increase significantly—at which point state 2 can be selected to significantly increase cooling.

Variations fall within the scope of the present invention.

The most common embodiment of the present invention is as described above—that is for the gearbox to be arranged co-axially with the impeller and driven by a belt from the engine. It will be noted that it is also possible to provide the gearbox co-axially with the engine output and drive the impeller via a belt (or other drive transmission) from the output shaft.

The planetary gear sets in the first embodiment are provided with the same ratio, providing three possible gearbox ratios. It is envisaged that different gear set ratios could be provided to afford four overall gearbox ratios.

Two planetary gear sets are provided in the first embodiment, but it is envisaged that three or more could be used in the same way to provide further gearing options and variability.

Although the above examples have the sun gears driving the planet carriers with stationary ring gears, different arrangements could be used depending on the ratios required.

It is conceivable that more than three planet gears are provided in each set.

Dog clutches are used in the above embodiment to rotationally lock parts together, but this could also be done with other clutches, including but not limited to friction or magnetic clutches.

The clutch arrangement from the second embodiment (i.e. a slideable drive plate providing a force path between the input/sun and planet carrier via a clutch) may be utilised with one or both gear sets in the first embodiment.

The compression springs 175 could be replaced by a single compression spring.

Although the above second embodiment describes ECU control based on engine temperature, it will be noted that other control mechanisms may be provided (for example a dedicated controller) and the input variable may be engine temperature, coolant temperature, engine load or any other engine parameter as appropriate.

What is claimed is:

1. An internal combustion engine coolant apparatus comprising:
an input shaft;
an output shaft configured to drive an impeller; and,
a gearbox between the input shaft and the output shaft, the gearbox comprising:
a planetary gear set configured to be driven by the input shaft, the gearbox being switchable between:
a first condition in which the planetary gear set has a first gear ratio; and,
a second condition in which the planetary gear set has a second ratio lower than the first; and,
an electrically powered actuator configured to switch between the first and second conditions;
in which the gearbox has a failsafe condition in which the first condition is entered upon interruption of power to the electrically powered actuator.

2. An internal combustion engine coolant apparatus according to claim 1, in which the actuator is configured to drive a displaceable drive member between the first and second conditions, in which the drive member is resiliently biased to the first condition.

3. An internal combustion engine coolant apparatus according to claim 2, in which the drive member is biased by a spring.

4. An internal combustion engine coolant apparatus according to claim 3, in which the actuator comprises an electromagnet configured to urge the drive member into the second condition.

5. An internal combustion engine coolant apparatus according to claim 4, in which the electromagnet is a solenoid.

6. An internal combustion engine coolant apparatus according to claim 5, in which the drive member comprises a material responsive to a magnetic field.

7. An internal combustion engine coolant apparatus according to claim 4, in which the electromagnet is annular in shape, centred on a main axis of the gear set.

8. An internal combustion engine coolant apparatus according to claim 1, in which the output shaft is driven by a planet carrier of the planetary gear set.

9. An internal combustion engine coolant apparatus according to claim 8, comprising a clutch between the drive member and the planet carrier, the clutch being engageable by movement of the drive member from the second to the first condition.

10. An internal combustion engine coolant apparatus according to claim 9, in which the planet gears define a plurality of planet gear axes at a planet gear radius from the main axis of the planetary gear set, and in which the clutch comprises opposed mating surface which are at least partially radially outboard of the planet gear radius.

11. An internal combustion engine coolant apparatus according to claim 10, in which the opposed mating surfaces of the clutch are fully radially outboard of the planet gear radius.

12. An internal combustion engine coolant apparatus according to claim 11, in which the opposed mating surfaces are radially inboard of the ring gear outer radius.

13. An internal combustion engine coolant apparatus comprising:
an input shaft;
an output shaft configured to drive an impeller; and,
a gearbox between the input shaft and the output shaft, the gearbox comprising:
a planetary gear set configured to be driven by the input shaft, the gearbox being switchable between:
a first condition in which the planetary gear set has a first gear ratio; and,
a second condition in which the planetary gear set has a second ratio lower than the first; and,
an electrically powered actuator comprising an electromagnet configured to switch the gearbox between the first and second conditions.

14. An internal combustion engine coolant apparatus according to claim 13, in which the actuator is configured to drive a displaceable drive member from one of the first and second conditions, in which the drive member is resiliently biased to the other of the first and second conditions.

15. An internal combustion engine coolant apparatus according to claim 14, in which the actuator is configured to drive a displaceable drive member from the first to the second condition, in which the drive member is resiliently biased to the first condition.

16. An internal combustion engine coolant apparatus according to claim 15, in which the drive member comprises a material responsive to a magnetic field.

17. An internal combustion engine coolant apparatus comprising:
an input shaft;
an output shaft configured to drive an impeller; and,
a gearbox between the input shaft and the output shaft, the gearbox comprising:
a first planetary gear set configured to be driven by the input shaft; and, a second planetary gear set configured to be driven by the first planetary gear set, and configured to drive the output shaft.

18. An internal combustion engine coolant apparatus according to claim 17, in which the first and second planetary gear sets are both configured to provide a reduction gear ratio.

19. An internal combustion engine coolant apparatus according to claim 17, in which the gearbox is provided with more than one selectable state, in which each state has a different gear ratio between the input shaft and output shaft.

20. An internal combustion engine coolant apparatus according to claim 17, in which the input shaft drives a sun gear of the first planetary gearbox, and in which a planet carrier of the first planetary gear set drives a sun gear of the second planetary gear set.
